(19) United States
(12) Patent Application Publication
(10) Pub. No.: US 2010/0196061 A1
(43) Pub. Date: Aug. 5, 2010

(54) IMAGE FORMING APPARATUS AND IMAGE FORMING METHOD

(75) Inventors: Satoshi CHIBA, Suwa-shi (JP); Ken IKUMA, Suwa-shi (JP)

Correspondence Address: Workman Nydegger;1000 Eagle Gate Tower, 60 East South Temple, Salt Lake City, UT, 84111, US

(73) Assignee: SEIKO EPSON CORPORATION, Tokyo (JP)

(21) Appl. No.: 12/696,495

(22) Filed: Jan. 29, 2010

(30) Foreign Application Priority Data
Feb. 2, 2009 (JP) 2009-021145

(51) Int. Cl. G03G 15/16

(52) U.S. Cl. 399/297

(57) ABSTRACT

An image forming apparatus and an image forming method are disclosed. The image forming apparatus includes a transfer belt that carries an image, a transfer roller that transfers the image carried on the transfer belt to a transfer material, a transfer material transporting unit that sucks a second surface, which is opposite to a first surface that is transferred the image, of the transfer material by air, and transports the transfer material along a transport surface, and a fixing unit that fixes the transfer material transported by the transfer material transporting unit.

### BACKGROUND

1. Technical Field

The present invention relates to an image forming apparatus and an image forming method which develop a latent image formed on a photoconductor by a liquid developer consisting of toner and a carrier, transfers the developer to a medium such as recording paper, and fuses and fixes the transferred toner image onto the medium to form an image.

2. Related Art

There are known various wet image forming apparatuses which develop a latent image by using a high-viscosity liquid developer, of which toner consisting of solid components is dispersed in a liquid solvent, to visualize an electrostatic latent image. The developer used in the wet image forming apparatus contains solid contents (toner particles) suspended in a high-viscosity organic solvent (carrier solution) consisting of silicon oil, mineral oil or cooking oil and having an electric insulating property, and the toner particles are very fine with a grain size of about 1 μm. In the wet image forming apparatus using the fine toner particles, it is possible to enhance the quality of an image as compared to a dry image forming apparatus using powder toner particles having a grain size of about 7 μm. As such an image forming apparatus using the liquid developer, for example, JP-A-2008-90114 discloses an image forming apparatus including a first fixing device that brings an image over a transfer material in contact with the transfer material to heat the image, a second fixing device that is placed at the downstream side of the first fixing device in a transport direction of the transfer material and brings the image over the transfer material in contact with the transfer material to heat the image, and an electric field applying unit that is positioned between the first fixing device and the second fixing device and applies an electric field to the transfer material.

In a fixing unit of the image forming apparatus disclosed in JP-A-2008-90114, a fixing unit is provided with two fixing devices having the first fixing device and the second fixing device to perform the fixation, but there is a problem in that even though the fixing device of two-staged configuration is used, the fixing efficiency is not always improved.

### SUMMARY

According to an aspect of the invention, there is provided an image forming apparatus including a transfer belt that carries an image, a transfer roller that transfers the image carried on the transfer belt to a transfer material, a transfer material transporting unit that sucks a second surface, which is opposite to a first surface that is transferred the image, of the transfer material by air, and transports the transfer material along a transport surface, and a fixing unit that fixes the transfer material transported by the transfer material transporting unit.

Further, in this case, the transfer material transporting unit transports the transfer material, with the first surface that is transferred the image of the transfer material facing vertically downward.

In addition, in this case, a suction unit is provided between the transfer material transporting unit and the transfer roller to suck the transfer material by air flow.

Moreover, in this case, an air flow control unit that controls an air volume of the air flow when the transfer material is sucked by the suction unit is further included.

Still further, in this case, the transfer roller has an elastic layer, and an opposite roller contacting the transfer roller via the transfer belt, in which the transfer roller has a diameter larger than that of the opposite roller.

Still further, in this case, a suction surface, which sucks the transfer material, of the suction unit is provided vertically underneath the transport surface, which transports the transfer material, of the transfer material transporting unit.

According to another aspect of the invention, there is provided an image forming method including carrying an image by a transfer belt, transferring the image carried on the transfer belt to a transfer material by a transfer roller, sucking a second surface, which is opposite to a first surface that is transferred the image, of the transfer material by a transfer material transporting unit using air flow to transport the transfer material along a transport surface, and fixing the transfer material transported by the transfer material transporting unit.

Further, in this case, the transfer material transporting unit transports the transfer material, with the first surface that is transferred the image of the transfer material facing vertically downward.

According to the image forming apparatus and the image forming method of the invention, since there is provided a layout in which a transfer material transporting device exists, a predetermined time can be gained by the transport time of the transfer material until fixation is performed after secondary transfer, thereby obtaining a proper fixing efficiency in the fixing unit.

In addition, according to the image forming apparatus and the image forming method of the invention, the transfer material transporting device transports the transfer material, with the surface that is transferred the image of the transfer material facing vertically downward. According to the transport posture of the transfer material, since the image forming surface faces downward at the paper ejection side after fixation, post-processing equipment such as a creaser or bookmaking machine may be placed next to the fixation, so that it is suitable for the layout of an image forming apparatus capable of performing continuous printing en masse.

Moreover, since the image forming apparatus and the image forming method of the invention includes the image forming apparatus according to the invention further includes the air flow control unit that controls the air volume of the air flow when the transfer material is sucked by a suction device, it can implement an apparatus capable of coping with various kinds of paper by controlling the air volume depending upon the classification of the transfer material.

Further, if the opposite roller is configured to have a large diameter, a circumferential length of the transfer belt is extended in conformity with this. If the circumferential length of the transfer belt is extended, the cost of the transfer belt is increased, or it is difficult to fabricate the belt in the first place. However, in the image forming apparatus and the image forming method of the invention, since an elastic layer is formed on a surface layer of the transfer roller, with the transfer belt being interposed between the transfer roller and the elastic surface, the diameter of the transfer roller is larger than that of the opposite roller opposite to the transfer roller. As a result, the width of a secondary transfer nip can be increased, and the circumferential length of the transfer belt can be shortened.

In addition, according to the image forming apparatus and the image forming method of the invention, since the suction surface, which sucks the transfer material, of the suction device is provided vertically underneath the transport surface, which transports the transfer material, of the transfer material transporting unit, it is possible to prevent the transfer material with creases such as a curl from being dragged between the suction device and the transfer material transporting device.

### BRIEF DESCRIPTION OF THE DRAWINGS

The invention will be described with reference to the accompanying drawings, wherein like numbers reference like elements.

FIG. 1 is a diagram illustrating major constituent components constituting an image forming apparatus according to an embodiment of the invention.

FIG. 2 is a diagram illustrating operation of a transfer material transporting unit used in the image forming apparatus of the invention.

FIG. 3 is a diagram illustrating operation of a transfer material transporting unit used in the image forming apparatus of the invention.

FIG. 4 is a diagram schematically illustrating a control block in the image forming apparatus according to an embodiment of the invention.

FIG. 5 is a diagram illustrating a preferred positioning relationship of each component in the image forming apparatus according an embodiment of the invention.

### DESCRIPTION OF EXEMPLARY EMBODIMENTS

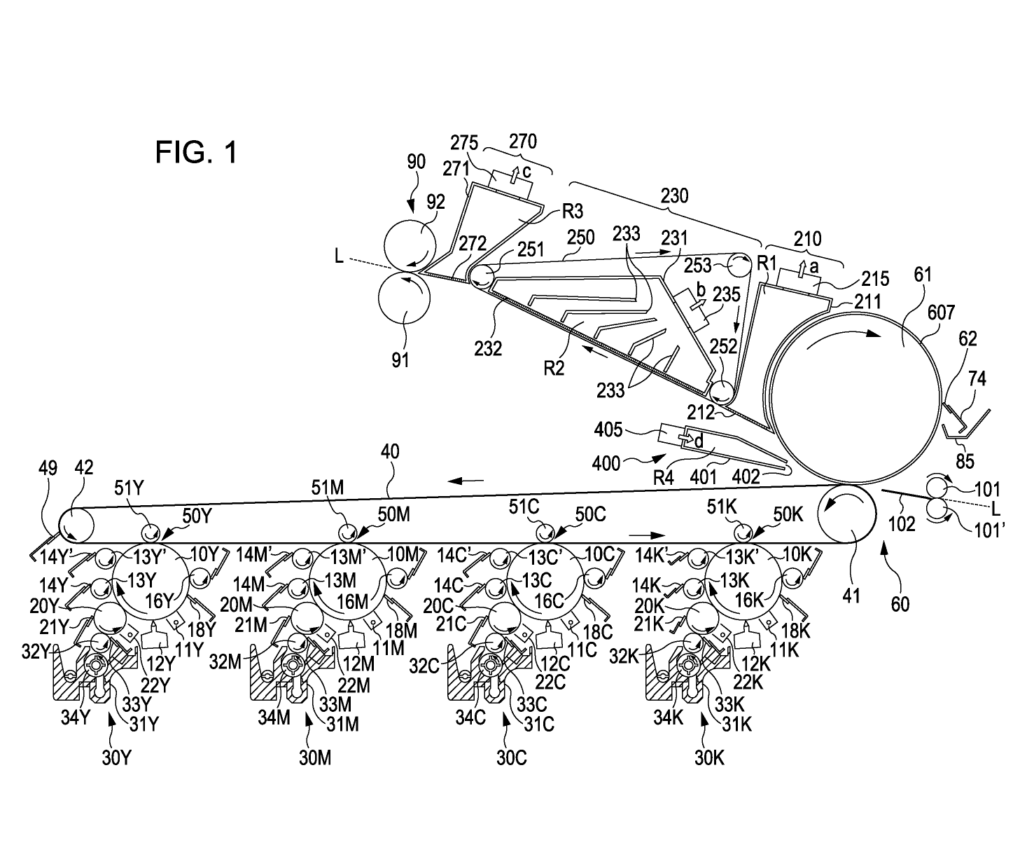

An embodiment of the invention will now be described with reference to the accompanying drawings. FIG. 1 is a diagram illustrating major constituent components constituting an image forming apparatus according to an embodiment of the invention. In an image forming unit for each color which is placed at the center portion of the image forming apparatus, developing devices 30Y, 30M, 30C, and 30K are placed at a lower portion of the image forming apparatus, and a configuration, such as transfer belt 40, secondary transfer unit (secondary transfer unit) 60, fixing unit 90 or the like, is placed at an upper portion of the image forming apparatus. In particular, since the fixing unit 90 is laid out over the transfer belt 40, it is possible to suppress the installation area of the whole image forming apparatus. In this embodiment, because of the configuration in which a transfer material such as paper, which is secondarily transferred by the secondary transfer unit 60, is sucked by a transfer material transporting device 230 or suction devices 210 and 270 and is transported to the fixing unit 90, such a layout can be implemented.

The developing devices 30Y, 30M, 30C, and 30K include photoconductors 10Y, 10M, 10C, and 10K, corona chargers 11Y, 11M, 11C, and 11K, exposing units 12Y, 12M, 12C, and 12K, such as LED array, and so forth, in order to form an image by a toner. The photoconductors 10Y, 10M, 10C, and 10K are uniformly discharged by the corona chargers 11Y, 11M, 11C, and 11K, and then are exposed by the exposing units 12Y, 12M, 12C, and 12K based on an input image signal, so that electrostatic latent images are formed on the charged photoconductors 10Y, 10M, 10C, and 10K.

The developing devices 30Y, 30M, 30C, and 30K mainly include developing rollers 20Y, 20M, 20C, and 20K, developer containers (reservoir) 31Y, 31M, 31C, and 31K for storing a liquid developer of each color including yellow (Y), magenta (M), cyan (C) and black (K), anilox rollers 32Y, 32M, 32C, and 32K serving as application rollers for applying the liquid developers of each color onto the developing rollers 20Y, 20M, 20C, and 20K from the developer containers 31Y, 31M, 31C, and 31K, and the like. The developing devices 30Y, 30M, 30C, and 30K develop the electrostatic latent images formed on the photoconductors 10Y, 10M, 10C, and 10K by the liquid developer of each color.

The transfer belt 40 is an endless belt, and is suspended in a tensioned state around a belt driving roller 41 and a tension roller 42. The transfer belt 40 is rotated by the belt driving roller 41, with the transfer belt abutting against the photoconductors 10Y, 10M, 10C, and 10K through primary transfer units 50Y, 50M, 50C, and 50K. The primary transfer units 50Y, 50M, 50C, and 50K include primary transfer rollers 51Y, 51M, 51C, and 51K placed in opposite to the photoconductors 10Y, 10M, 10C, and 10K, with the transfer belt 40 being interposed between the photoconductors and the transfer rollers, and sequentially overlay and transfer a developed toner image of each color on the photoconductors 10Y, 10M, 10C, and 10K onto the transfer belt 40 at a transfer position which corresponds to a position abutting against the photoconductors 10Y, 10M, 10C, and 10K, thereby forming a full color toner image.

A secondary transfer unit 60 includes a secondary transfer roller 61 placed opposite to the belt driving roller 41 across the transfer belt 40, and a cleaning device having a secondary transfer roller cleaning blade 62. At a transfer position in which the secondary transfer roller 61 is placed, a monochromatic toner image or a full color toner image formed on the transfer belt 40 is transferred on a transfer material, such as paper, film or cloth, transported along a transfer material transporting path L.

In addition, a first suction device 210, a transfer material transporting device 230 and a second suction device 270 are sequentially arranged at the downstream side of the transfer material transporting path L, thereby transporting the transfer material to the fixing unit 90. In the fixing unit 90, the monochromatic toner image or the full color toner image transferred on the transfer material such as paper is fused and fixed on the transfer material such as paper.

The tension roller 42 suspends the transfer belt 40 in a tensioned state together with the belt driving roller 41, and is placed to abut against the cleaning device constituted by the transfer belt cleaning blade 49 at a position in which the tension roller 42 of the transfer belt 40 is suspended in a tensioned state, thereby cleaning the toner and the carrier remaining on the transfer belt 40.

A superficial elastic member 607 is provided on a superficial portion of the secondary transfer roller 61. The superficial elastic member 607 is made of a semi-conductive elastic rubber layer having an electric resistance component. In addition, if the belt driving roller 41 is configured to have a large diameter, a circumferential length of the transfer belt 40 is extended in conformity with this. If the circumferential length of the transfer belt 40 is extended, the cost of the transfer belt is increased, or it is difficult to fabricate the belt in the first place. However, in the image forming apparatus of the invention, since the superficial elastic member 607 is formed on the surface layer of the secondary transfer roller 61, with the transfer belt 40 being interposed between the transfer roller and the superficial elastic member, the diameter of the secondary transfer roller 61 is larger than that of the belt driving roller 41 opposite to the secondary transfer roller 61. As a result, the width of a secondary transfer nip can be increased, and the circumferential length of the transfer belt can be shortened. In this instance, in the liquid developing manner, it is possible to obtain a secondary transfer efficiency properly relative to a case in which the width of the secondary transfer nip is enlarged.

Supply of the transfer material into the image forming apparatus is performed by a paper feeding device (not shown). The transfer material set in such a paper feeding device is configured to be fed along the transfer material transporting path L each sheet at a predetermined timing. At the transfer material transporting path L, the transfer material is transported to the secondary transfer position by gate rollers 101 and 101′ and a transfer material guide 102 to transfer a monochromatic toner developed image or a full color toner developed image formed on the transfer belt 40 onto the transfer material. The secondarily transferred transfer material is further transferred to the fixing unit 90 by a transfer material transporting unit constituting of the transfer material transporting device 230 as a main component. The fixing unit 90 is constituted of a heating roller 91 and a pressing roller 92 which is biased toward the heating roller 91 side with predetermined pressure. The fixing unit 90 inserts the transfer material between the nips to fuse and fix the monochromatic toner image or the full color toner image transferred to the transfer material onto the transfer material such as paper.

Although the developing device is described herein, since the configuration of the image forming unit is identical to the configuration of the developing device for each color, it will be described based on the image forming unit and the developing device for yellow (Y).

The image forming unit is constituted of a photoconductor cleaning roller 16Y, a photoconductor cleaning blade 18Y, the corona charger 11Y, the exposing unit 12Y, the developing roller 20Y of the developing device 30Y, a first photoconductor squeezing roller 13Y, and a second photoconductor squeezing roller 13Y′ which are placed along an outer circumferential rotation direction of the photoconductor 10Y.

The photoconductor cleaning roller 16Y abuts against the photoconductor 10Y, and is rotated in a counterclockwise direction, thereby cleaning the liquid developer remaining on the photoconductor 10Y or a liquid developer which is not transferred. The photoconductor cleaning roller 16Y is applied with a bias voltage so as to attract toner particles contained in the liquid developer, and recovered material from the photoconductor cleaning roller 16Y becomes a solid content-rich liquid developer containing many toner particles.

At a downstream side of the photoconductor cleaning roller 16Y, the photoconductor cleaning blade 18Y abutting against the photoconductor 10Y cleans the carrier component-rich liquid developer on the photoconductor 10Y.

In the developing device 30Y, the cleaning blade 21Y, the anilox roller 32Y, and a compaction corona generator 22Y are placed on the outer circumference of the developing roller 20Y. The anilox roller 32Y abuts against an adjusting blade 33Y for adjusting the amount of the liquid developer supplied to the developing roller 20Y. An auger 34Y is accommodated in the liquid developer container 31Y. Further, a primary transfer roller 51Y of the primary transfer unit is placed at a position opposite to the photoconductor 10Y, with the transfer belt 40 being interposed between the photoconductor and the transfer belt.

The photoconductor 10Y is a photoconductor drum formed in a cylindrical member, of which a photosensitive layer such as amorphous silicon photoconductor is formed on an outer circumferential surface, and is rotated in a clockwise direction.

The corona charger 11Y is placed at a farther upstream side, in a rotation direction, of the photoconductor 10Y than a nip portion between the photoconductor 10Y and the developing roller 20Y, and is applied with a voltage from power device (not shown) to corona-charge the photoconductor 10Y. The exposing unit 12Y irradiates light on the photoconductor 10Y charged by the corona charger 11Y at a farther downstream side, in a rotation direction, of the photoconductor 10Y than the corona charger 11Y, thereby forming a latent image on the photoconductor 10Y. In this instance, from the beginning to the end of the image forming process, the configuration of the roller or the like placed at a farther leading end is defined by its placed at a farther upstream side than that of the roller or the like placed at a trailing end.

The developing device 30Y includes the compaction corona generator 22Y for performing a compaction operation, and the developer container 31Y for storing the liquid developer therein, the liquid developer having a ratio of about 20% by weight which is dispersed in the carrier.

Further, the developing device 30Y includes the developing roller 20Y carrying the liquid developer, the anilox roller 32Y serving as an application roller for applying the liquid developer onto the developing roller 20Y, the regulating blade 33Y for regulating an amount of the liquid developer to be applied onto the developing roller 20Y, an auger 34Y mixing and transporting the liquid developer and supplying it to the anilox roller 32Y, the compaction corona generator 22Y converting the liquid developer carried on the developing roller 20Y into a compaction state, and the developing roller cleaning blade 21Y cleaning the developing roller 20Y.

The liquid developer contained in the developer container 31Y is not a volatile liquid developer of low concentration (about 1 to 2 wt %) and viscosity having a volatile property at ambient temperature, of which Isopar (trademark; Exxon) commonly used in the art is used as a carrier, but a volatile liquid developer of high concentration and viscosity and having a volatile property at ambient temperature. That is, the liquid developer of the invention is a liquid developer of high viscosity (about 30 to 10000 mPa·s), of which solid particles having an average grain size of 1 μm which are formed by dispersing a coloring agent such as pigment into a thermoplastic resin, are added to an organic solvent or a liquid solvent such as silicon oil, mineral oil or cooking oil and concentration of the toner solid content is set to about 20%.

The anilox roller 32Y serves as an application roller for supplying and applying the liquid developer onto the developing roller 20Y. The anilox roller 32Y is a cylindrical member, and is a roller with a concave/convex surface formed with grooves finely and uniformly carved in a spiral shape so as to easily carry the developer on the surface. The liquid developer is supplied from the developer container 31Y to the developing roller 20Y by the anilox roller 32Y. At the time of operating the apparatus, as shown in FIG. 1, the auger 34Y is rotated in a counterclockwise direction to supply the liquid developer to the anilox roller 32Y, and the anilox roller 32Y is rotated in a counterclockwise direction to apply the liquid developer onto the developing roller 20Y.

The adjusting blade 33Y is an elastic blade which is formed by applying an elastic material on a surface thereof, and is constituted of a rubber portion which is made of urethane rubber or the like and abuts against the surface of the anilox roller 32Y. In addition, the adjusting blade regulates and adjusts the film thickness and the amount of liquid developer carried and transported by the anilox roller 32Y, and adjusts the amount of the liquid developer to be supplied to the developing roller 20Y.

The developing roller cleaning blade 21Y is made of rubber or the like which abuts against the surface of the developing roller 20Y, and is placed at the downstream side, in a rotation direction, of the developing roller 20Y at a developing nip portion at which the developing roller 20Y abuts against the photoconductor 10Y, to scrape and remove the liquid developer remaining on the developing roller 20Y.

The compaction corona generator 22Y is an electric field applying unit for increasing a charging bias of the surface of the developing roller 20Y, and an electric field is applied from the compaction corona generator 22Y side to the developing roller 20Y at a compaction portion by the compaction corona generator 22Y. In this instance, the electric field applying unit for compaction may use a compaction roller, instead of corona discharge of the corona discharger shown in FIG. 1.

The compacted developer carried on the developing roller 20Y is developed in a shape corresponding to the latent image of the photoconductor 10Y at the developing nip portion, at which the developing roller 20Y abuts against the photoconductor 10Y, by application of a predetermined electric field.

The developer remaining at the development is scraped and removed by the developing roller cleaning blade 21Y, and is dropped in a recovery portion in the developer container 31Y for the purpose of reuse. In this instance, carrier and toner reused in this way do not exist in a mixed color.

A photoconductor squeezing device placed at the upstream side of the primary transfer is placed at the downstream side of the developing roller 20Y opposite to the photoconductor 10Y to recover the surplus carrier of an toner image developed on the photoconductor 10Y. The photoconductor squeezing device is constituted by the first photoconductor squeezing roller 13Y and the second photoconductor squeezing roller 13Y′ which are made of an elastic roller member and are rotated in slide contact with the photoconductor 10Y. The photoconductor squeezing device has a role of recovering the surplus carrier and unnecessary fog toner from the toner image developed on the photoconductor 10Y to increase a ratio of toner particles in a visualized image (toner image). In this instance, the photoconductor squeezing rollers 13Y and 13Y′ are applied with a predetermined bias voltage.

The surface of the photoconductor 10Y passing through a squeezing device constituted of the first photoconductor squeezing roller 13Y and the second photoconductor squeezing roller 13Y′ enters the primary transfer unit 50Y.

In the primary transfer unit 50Y, the developer image developed on the photoconductor 10Y is transferred to the transfer belt 40 by the primary transfer roller 51Y. In the primary transfer unit, the toner image on the photoconductor 10 is transferred to the transfer belt 40 side by action of the transfer bias applied to the primary transfer backup roller 51. The photoconductor 10Y and the transfer belt 40 are configured to move at uniform velocity, and has a role of lowering the drive load of rotation and movement and suppressing disturbance action on the visualized image toner image developed on the photoconductor 10Y.

By the same process as the developing process of the developing device 30Y, the toner images of magenta (M), cyan (C) and black (K) are respectively formed on the photoconductors 10M, 10C and 10K in the developing devices 30M, 30C and 30K. The transfer belt 40 passes through the nip of the primary transfer unit 50 of each color, i.e., yellow (Y), magenta (M), cyan (C) and black (K) to transfer the developer (developed image) on the photoconductor of each color, and enters the nip portion of the secondary transfer unit 60 to overlay the color.

The transfer belt 40 passing the secondary transfer unit 60 is rotated around the primary transfer unit 50 so as to again receive the transfer image from the primary transfer unit 50, but the transfer belt 40 is cleaned by the transfer belt cleaning blade 49 or the like at the upstream side at which the primary transfer unit 50 is executed.

The transfer belt 40 has a three-layered structure of a polyimide base layer, an intermediate elastic layer of polyurethane formed on the polyimide base layer, and a PFA surface layer formed on the intermediate elastic layer. The transfer belt 40 is suspended in a tensioned state around the driving roller 41 and the tension roller 42 at the polyimide base layer side, and the toner image is transferred on the PFA surface layer side. Since the elastic transfer belt 40 having such a configuration has a good following property and good responsibility with respect to the surface of the transfer material, it is especially effective to send and transfer the toner particles of small grain size into the concave portions of the transfer material at the time of secondary transfer.

As shown in FIG. 1, a paper feeding side and a paper ejection side of the transfer material may be symmetrically disposed on the center of the secondary transfer unit 60. That is, in FIG. 1, the transfer material is fed toward the right side, and is ejected toward the left side through fixation. According to this configuration, since the pre-processing equipment for controlling the posture of the paper or treating the paper may be placed at the paper feeding side and post-processing equipment such as creaser or bookmaking machine may be placed at the paper ejection side, it is suitable for the layout of an image forming apparatus capable of performing continuous printing en masse.

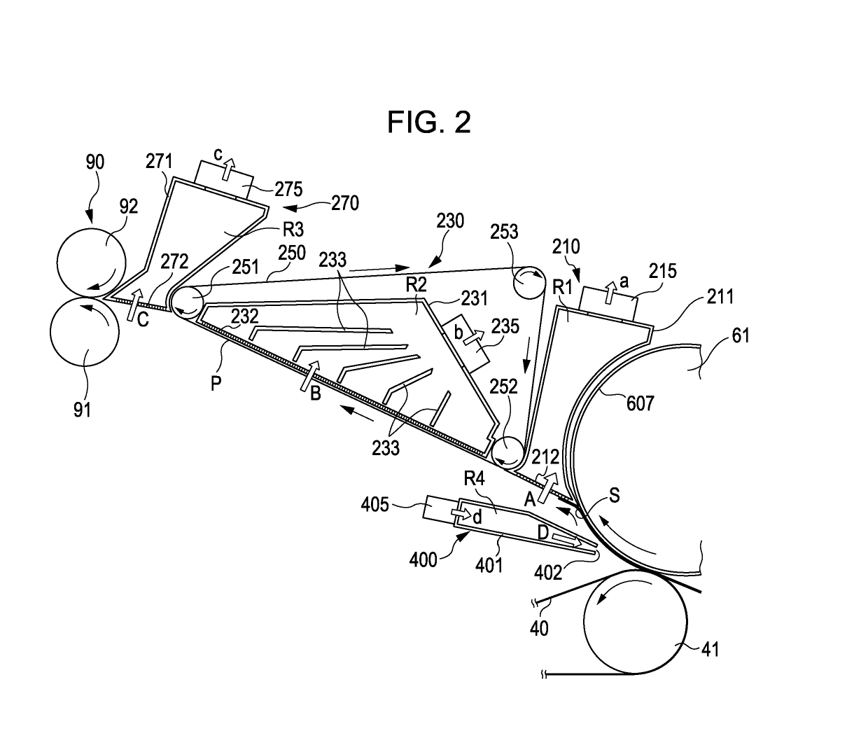

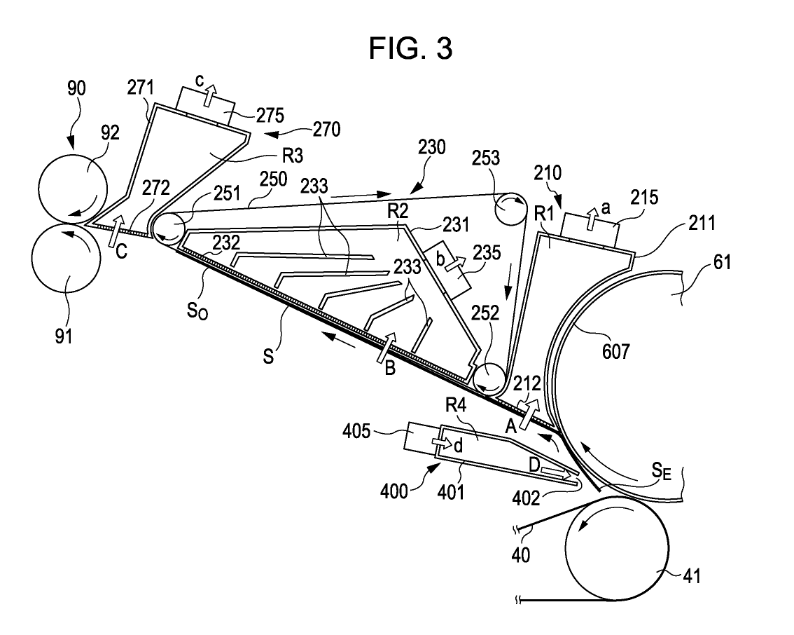

The transfer material transferred with the toner image at the secondary transfer unit 60 is next transported to the transfer unit 90, and the transport unit for performing the transport will be described below. FIGS. 2 and 3 are diagrams illustrating the operation of the transfer material transporting unit used in the image forming apparatus according to this embodiment of the invention. In FIGS. 2 and 3, reference numeral 210 denotes a first suction device, 211 denotes a casing portion, 212 denotes a suction surface, 215 denotes an air flow generator, 230 denotes a transfer material transporting device, 231 denotes a casing portion, 232 denotes a suction surface, 233 denotes a partition member, 235 denotes an air flow generator, 250 denotes a transfer material transporting member, 251 denotes a transfer-sheet transporting member driving roller, 252 and 253 denote a transport-sheet transporting member suspending roller, 270 denotes a second suction device, 271 denotes a casing portion, 272 denotes a suction surface, 275 denotes an air flow generator, 400 denotes a blast device, 401 denotes a casing portion, 402 denotes an opening portion, and 405 denotes an air flow generator.

The first suction device 210 includes the casing portion 211 attached with the air flow generator 215 such as a Sirocco fan or the like, so that exhaust from an internal space R1 of the casing portion 211 to the exterior of the casing portion 211 can be performed by the air flow generator 215. The bottom surface side of the casing portion 211 serves as the suction surface 212 provided with a plurality of ventilation holes at one surface thereof. The first suction device 210 operates the air flow generator 215 to discharge the air outwardly from the casing portion 211 as indicated by a mark ‘a’, thereby generating a suction force as indicated by a mark ‘A’. Due to the suction force, the transfer material S transferred with the toner image is maintained against gravity by the suction surface 212. The suction force is capable to the extent of maintaining the transfer material S on the suction surface 212, but is not capable to the extent of preventing the transfer material S from proceeding against a force pushing the transfer material S from the secondary transfer nip.

The transfer material transporting device 230 includes the casing portion 231 attached with the air flow generator 235 such as a Sirocco fan or the like, and the transfer material transporting unit 250 placed in the vicinity of the casing portion 231. The transfer material transporting member 230 is adapted to discharge the air from the internal space R2 of the casing portion 231 to the exterior of the casing portion 231 by the air flow generator 235.

The bottom surface side of the casing portion 231 serves as the suction surface 232 provided with a plurality of ventilation holes at one surface thereof. According to ventilation operation ‘b’ of the air flow generator 235, a suction force is generated on the suction surface 232, as indicated by B. In this instance, ventilation is relatively uniformly performed from the internal space R2 of the casing portion 231 by action of the partition member 233 provided in the casing portion 231, and the suction force is generated on the suction surface 232 without biasing depending upon a location.

The transfer material transporting unit 250 placed in the vicinity of the casing portion 231 is an endless belt provided with a plurality of ventilation holes (not shown) penetrating from one main surface to the other main surface. The transfer material transporting unit 250 is suspended in a tensioned state around the transfer-sheet transporting member driving roller 251 applying a driving force to the transfer material transporting unit 250, and the transfer-sheet transporting member suspending rollers 252 and 253. The transfer material transporting unit 250 is moved in a direction indicated by an arrow in the figure as the transfer-sheet transporting member driving roller 251 is rotated. The moving velocity is set to be approximately equal to the velocity of the image forming process. The transfer material transporting unit 250 has an axial length (width of the transfer material transporting unit 250) longer than the maximum width of the transfer material which can be obtained by treating the image forming apparatus.

The suction force on the suction surface 232 of the casing portion 231 is also generated by the ventilation holes of the transfer material transporting unit 250, so that the transfer material S transferred with the toner image is maintained on the transport surface P of the transfer material transporting unit 250 against the gravity and is transported on the transport surface P in accordance with movement of the transfer material transporting unit 250 by the driving force of the transfer-sheet transporting member driving roller 251. The region between the transfer-sheet transporting member suspending roller 252 of the transfer material transporting unit 250 and the transfer-sheet transporting member driving roller 251 is used as the transport surface P transporting the transfer material S.

The second suction device 270 includes the casing portion 271 attached with the air flow generator 275 such as a Sirocco fan or the like, so that exhaustion from an internal space R3 of the casing portion 271 to an exterior of the casing portion 271 can be performed by the air flow generator 275. The bottom surface side of the casing portion 271 serves as the suction surface 272 provided with a plurality of ventilation holes at one surface thereof. The second suction device 270 can generate a suction force as indicated by a mark ‘C’ by ventilation operation ‘c’ of the air flow generator 275 of the second suction device 270. Due to the suction force, the transfer material S transferred with the toner image is maintained against gravity by the suction surface 272. The suction force is an extent capable of maintaining the transfer material S on the suction surface 272, but is not capable to the extent of preventing the transfer material S from proceeding against the force generated by the transport of the transfer material S.

The transfer material transporting unit constituting of the first suction device 210, the transfer material transporting device 230, the second suction device 270 and the like according to this embodiment transports the transfer material, with the surface, to which the toner image of the transfer material is transferred, facing vertically downward. According to the transport posture of the transfer material, since the image forming surface faces downward at the paper ejection side after fixation, post-processing equipment such as a creaser or bookmaking machine may be placed after the fixation, so that it is suitable for the layout of an image forming apparatus capable of performing continuous printing en masse.

The blast device 400 is adapted to eject air into the space between the transfer belt 40 and the secondary transfer roller 61 adjacent to the outlet of the secondary transfer nip, and the air is fed into the internal space R4 of the casing portion 401 by the air flow generator 405 such as Sirocco fan or the like. The casing portion 401 is provided with the opening portion 402 extending in an axial direction of a roller type, and the air sent into the casing portion 401 is discharged from the opening portion 402, as shown by D, according to the air flow generating operation d of the air flow generator 405. In this instance, the discharging force of the air is adjusted so as to prevent the transfer material S transferred with the toner image from sagging downward against the gravity and prevent the transfer material S from flying by influence of the air.

Next, the operation of the transfer material transporting unit having such a configuration according to the embodiment will be described. FIG. 2 illustrates a state immediately after the leading end (S₀) of the transfer material S in the transport direction is discharged from the secondary transfer nip of the secondary transfer unit 60, that is, the transfer material S is transferred from the secondary transfer unit 60 side to the transport unit. As show in the figure, the transfer material S is not dropped by the suction force A of the suction surface 212 which is generated by the operation ‘a’ of the air flow generator 215, but is maintained by the suction surface 212. The transfer material is slidingly transported on the suction surface 212 by the force of the transport operation from the secondary transfer unit 60 side. In this instance, since the surface of the transfer material S sucked by the suction surface 212 is a surface on which the toner image is not formed by the previous secondary transfer operation, a unfixed toner image is not confused in accordance with the transport operation by the transport unit. Further, since the first suction device 210 is installed in this embodiment, the discharged posture of the transfer material S can be stably maintained. As a result, it is possible to prevent the unfixed toner image from being confused by contacting the toner image forming surface of the transfer material S with the member such as the transfer belt 40 which is placed downward in the gravity direction. Further, since the first suction device 210 sucking the transfer material S is provided between the secondary transfer roller 61 and the transfer material transporting device 230, after the leading end of the transfer material is spaced apart from the belt or the transfer roller 61, the posture of the transfer material is followed by the air suction, thereby stabilizing the posture of the transfer material.

The leading end of, in the transport direction, the transfer material S influenced by the force of the moving operation from the secondary transfer unit 60 side and slidingly transported on the suction surface 212 of the first suction device 210 reaches the transfer material transporting device 230 side, the transfer material S is maintained by the suction force B on the transport surface P of the transfer material transporting unit 250, and the transport surface P faces the fixing unit 90 in accordance with the moving operation of the transfer material transporting unit 250.

FIG. 3 illustrates a state immediately after the trailing end (S_{E}) of the transfer material S in the transport direction is discharged from the secondary transfer nip of the secondary transfer unit 60. In particular, since the air is discharged by operation of the blast device 400, as shown by ⊃, when the trailing end (S_{E}) of the transfer material S is discharged from the secondary transfer nip, it is possible to prevent the image from being polluted or damaged due to a state in which the trailing end (S_{E}) of the transfer material comes in contact with the transfer belt 40 or the like.

In this embodiment, since there is provided the blast device 400 for discharging the air into the nip exit space between the secondary transfer roller 61 and the transfer belt 40, as described above, after the trailing end (S_{E}) of the transfer material is discharged from the secondary transfer nip, the trailing end is pushed toward the secondary transfer roller 61 side, thereby stabilizing the posture of the transfer material S after the secondary transfer nip discharge.

The transfer material S shown in FIG. 3 is a longest transfer material which can be obtained by the apparatus, when seen in the transport direction. When the longest transfer material is used in the image forming apparatus of the present invention, the dimension of each component is determined so that the transfer material S is not pinched at any of the fixing nip of the fixing unit 90 and the secondary transfer nip of the secondary transfer unit 60. Therefore, even though there is a difference in transport velocity of the transfer material S between the fixing unit 90 and the secondary transfer unit 60, it is possible to prevent a bad influence from being exerted on the image or the like, without loosening or tensioning the transfer material S.

Further, when the transfer material S is transported from the transport surface P of the transfer material transporting device 230 in the state in which the transfer material is pinched between the secondary transfer nips of the secondary transfer unit 60, even though there is a difference between the primary transport velocity of the secondary transfer unit 60 and the transport velocity of the transfer material transporting unit 250, the transfer material S maintained by the transfer material transporting unit 250 is maintained by only the suction force generated by the air, so that the transfer material is slid on the transfer material transporting unit 250. As a result, the transfer material S is not loosened or tensioned.

Similarly, when the transfer material S is transported from the transport surface P of the transfer material transporting device 230 in the state in which the transfer material is pinched between the fixing nips of the fixing unit 90, even though there is a difference between the transport velocity of the fixing unit 90 and the transport velocity of the transfer material transporting unit 250, the transfer material is slid on the transfer material transporting unit 250, so that the transfer material S is not loosened or tensioned.

As described above, the transfer material transporting device 230 can serve as a mechanism capable of absorbing the difference in the transport velocities of the transfer material S in each unit.

The transfer material S transported from the transport surface P of the transfer material transporting device 230 passes through the suction surface 272 of the second suction device 270, and enters the fixing nips formed by the heating roller 91 and the pressing roller 92 in the fixing unit 90. If the transfer material S passes through the fixing nip, the toner image is fused to form a permanent visible image.

In the image forming method using the liquid developer, if a predetermined time is set after the secondary transfer unit 60 performs the secondary transfer, there may be development in which it is possible to obtain a proper fixing efficiency in the fixing unit 90. The reason is that if the predetermined time is set, a carrier obstructing the fixation can infiltrate the transfer material. If a layout is taken in which the fixing unit 90 is provided just behind the secondary transfer unit 60, the transfer material S is transferred with the toner in the secondary transfer unit 60, and the toner is fixed after a short time, so that the fixing efficiency may deteriorate. According to the image forming apparatus of the invention, because of the layout in which the transport unit constituting of the first suction device 210, the transfer material transporting device 230, the second suction device 270 and the like is provided between the secondary transfer unit 60 and the fixing unit 90, a predetermined time can be gained by the time required for the transport of the transfer material S until the fixation is performed after secondary fixation, it is possible to obtain the proper fixing efficiency in the fixing unit 90.

Further, in the image forming apparatus according the invention, since the first suction device 210 sucking the transfer material S discharged from the secondary transfer unit 60 is provided, the transfer material S after the secondary transfer can be discharged to a space over the transfer belt 40. Since the fixing unit 90 can be placed by using the space, there is an effect of reducing an installation surface of the apparatus.

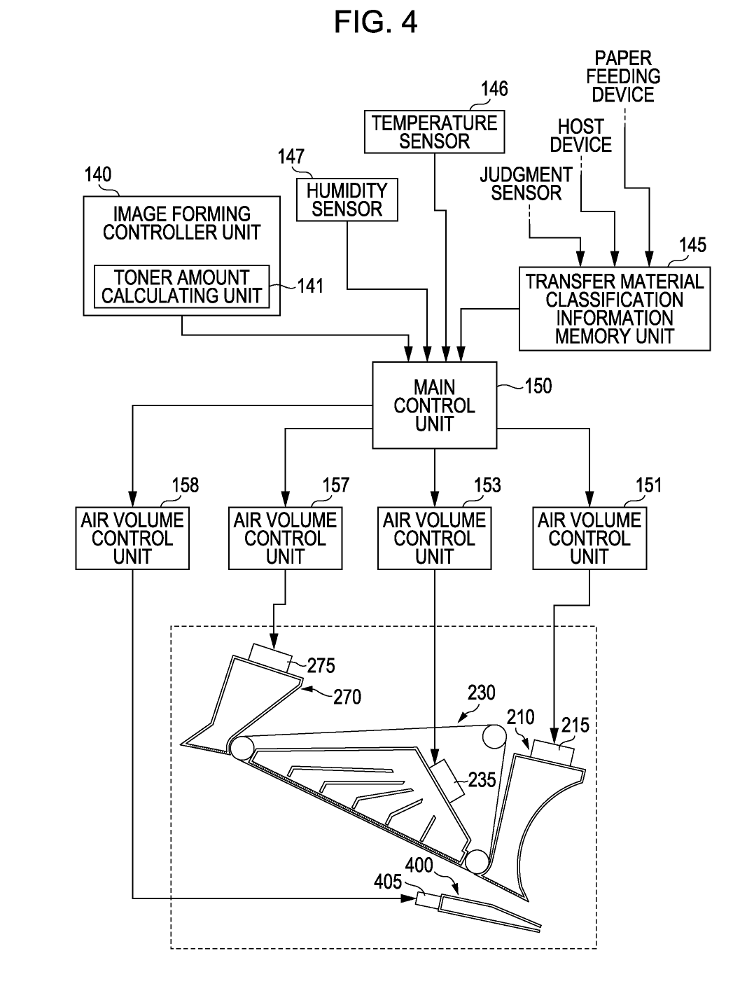

Next, the control of the image forming apparatus having such a configuration according to the invention will be described. FIG. 4 is a diagram schematically illustrating a control block in the image forming apparatus according an embodiment of the invention. In FIG. 4, reference numeral 140 denotes an image formation control unit, 141 denotes a toner amount calculating unit, 145 denotes a transfer material classification information memory unit, 146 denotes a temperature sensor, 147 denotes a humidity sensor, 150 denotes a main control unit. And 151, 153, 157 and 158 denotes an air flow control unit.

The main control unit 150 is a main controller for performing each control of the image forming apparatus according to the invention. The main control unit 150 employs a general-purpose information processing device including CPU, RAM, ROM and the like, and it is possible to operate the device by previously storing a program which lets a CPU to execute the operation of outputting a command to a predetermined block based on input predetermined information, in the ROM.

The transfer material classification information memory unit 145 is a memory unit for temporarily storing data on a classification of the transfer material on which an image is formed in the image forming apparatus. The transfer material classification information memory unit 145 is adapted to acquire, for example, information from a judgment sensor, installed in the image forming apparatus, for judging a classification of the transfer material, information from a host device outputting a command of executing image formation to the image forming apparatus, or information from the paper feeding device supplying the transfer material to the image forming apparatus, and store the information. The data on classification of the transfer material stored in the transfer material classification information memory unit 145 is properly used for the purpose of the control in the main control unit 150.

The temperature sensor 146 and the humidity sensor 147 are provided at proper positions of the image forming apparatus to acquire data on temperature and humidity and then send it to the main control unit 150 side. The main control unit 150 side receiving the data outputs a necessary control command based on the data. In this instance, when the image forming apparatus is configured, both or either of the temperature sensor 146 and the humidity sensor 147 may be provided.

The image formation control unit 140 is adapted to perform the control of the exposure in the exposing units 12Y, 12M, 12C and 12K based on the image signal input to the image forming apparatus, but the image formation control unit 140 is further provided with the toner amount calculating unit 141 for calculating the amount of the toner use to be predicted on the basis of the amount of exposure and exposure timing or the like when image formation is performed. A quantity of the toner transferred to the whole transfer material S can be predicted by the toner amount calculating unit 141. The data on the toner amount calculated by the toner amount calculating unit 141 is sent to the main control unit 150, and the main control unit 150 side received the data properly outputs a control command based on the data.

The air flow control units 151, 153, 157 and 158 control an air volume in the air flow generator 215 of the first suction device 210, the air flow generator 235 of the transfer material transporting device 230, the air flow generator 275 of the second suction device 270, and the air flow generator 405 of the blast device 400 at the time of generating the air flow. More specifically, the air flow control unit is a controller for performing velocity control of a motor provided in a fan which serves as each air flow generator. The main control unit 150 outputs a control command to the air flow control units 151, 153, 157 and 158 to control the air volume generated by each air flow generator. In this way, it is possible to freely control the suction force to the transfer material or the discharged air volume to the transfer material. In this instance, although this embodiment is described based on an example of controlling the air volume by controlling the motor of the fan, an openable/closable duct may be provided in each casing portion to control the air volume by opening or closing the duct.

The image forming apparatus of the invention includes the transfer material classification information memory unit 145, and can control the transport unit constituted of the first suction device 210, the transfer material transporting device 230 and the second suction device 270, and the blast device 400 based on the information on the classification of the transfer material, thereby easily changing conditions of the transfer material transport in accordance with the classification of the transfer material.

Further, the image forming apparatus of the invention includes the toner amount calculating unit 141, and can control the transport unit constituted of the first suction device 210, the transfer material transporting device 230 and the second suction device 270, and the blast device 400 based on the amount of the toner transferred to the transfer material, thereby easily changing conditions of the transfer material transport in accordance with the amount of the toner.

In addition, the image forming apparatus of the invention includes the temperature sensor 146 and the humidity sensor 147, and can control the transport unit constituted of the first suction device 210, the transfer material transporting device 230 and the second suction device 270, and the blast device 400 based on the temperature information and the humidity information obtained by these sensors, thereby easily changing conditions of the transfer material transport in accordance with a circumstance in which the image forming apparatus is placed.

Moreover, in the image forming apparatus according to the invention, the air flow control units 151, 153, and 157 serve as an air volume adjusting portion for controlling the air volume when the transfer material is sucked, and can adjust the suction force when the transfer material is sucked by the transport unit, such as the first suction device 210, the transfer material transporting device 230 and the second suction device 270 in accordance with the classification of the transfer material, thereby improving the responsiveness for the classification of the transfer material in the apparatus.

More specifically, for example, if thin paper is sucked by the same suction force as the suction force for thick paper, in the case of the thin paper, since the resilience thereof is weaker than the thick paper, the resilience of the paper does not withstand the suction force, so that the paper is not transported on the suction surface 212 and the suction surface 272 and thus stagnates, so that the paper winkles. However, if the suction force required for the thin paper is adjusted to half of the suction force required for the thick paper, the waist portion of the thin paper can be sufficiently transported, thereby preventing the paper from wrinkling.

Further, in the image forming apparatus according to the invention, the air flow control units 151, 153, and 158 serve as an air volume adjusting portion for controlling the air volume when the air is discharged by the blast device 400, and can adjust, for example, the air volume of the air discharged from the blast device 400 in accordance with the classification of the transfer material, thereby improving the responsiveness for the classification of the transfer material in the apparatus.

More specifically, if the thin paper is pushed against the secondary transfer nip exit space between the transfer belt 40 and the transfer roller 61 by the same discharged air volume as that for the thick paper, the paper flutters due to the discharged air. If the paper flutters, the image surface comes in contact with the member in the apparatus, so that the image is confused or the paper flutters to produce wrinkle on the paper. However, since the discharged air volume for the thin paper is set to half of that for the thick paper, it is possible to prevent the thin paper from fluttering and thus pushing the paper against the space side.

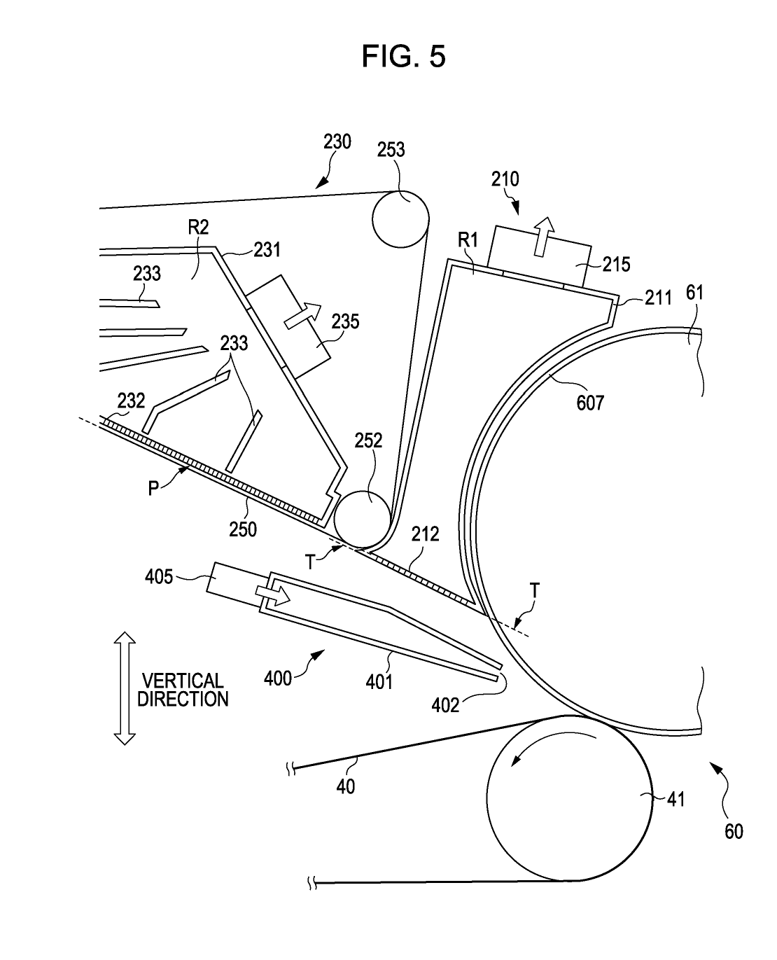

Next, the arrangement of the transfer material transporting device 230 and the like suitable for the image forming apparatus of the invention will be described. FIG. 5 is a diagram illustrating a preferred arrangement relationship of each configuration in the image forming apparatus according to an embodiment of the invention. According to the characteristic layout in this embodiment, the suction surface T, in which the suction surface 212 of the first suction device 210 sucks the transfer material, faces in a vertical downward direction, rather than the transport surface P, in which the transfer material transporting device 230 transports the transfer material. By defining the transport surface P and the suction surface T as described above, it is possible to prevent a transfer material with creases such as curls from being dragged between the first suction device 210 and the transfer material transporting device 230.

Although various embodiments are described herein, an embodiment formed by properly combining the configurations of each embodiment is within the scope of the invention.

The entire disclosure of Japanese Patent Application No: 2009-21145, filed Feb. 2, 2009 is expressly incorporated by reference herein.

What is claimed is:

1. An image forming apparatus comprising:
a transfer belt that carries an image;
a transfer roller that transfers the image carried on the transfer belt to a transfer material;
a transfer material transporting unit that sucks a second surface, which is opposite to a first surface that is transferred the image, of the transfer material by air, and transports the transfer material along a transport surface; and
a fixing unit that fixes the transfer material transported by the transfer material transporting unit.

2. The image forming apparatus according to claim 1, wherein the transfer material transporting unit transports the transfer material, with the first surface that is transferred the image of the transfer material facing vertically downward.

3. The image forming apparatus according to claim 1, wherein a suction unit is provided between the transfer material transporting unit and the transfer roller and that sucks the transfer material by air flow.

4. The image forming apparatus according to claim 1, further comprising an air flow control unit that controls a volume of the air flow when the transfer material is sucked by the suction unit.

5. The image forming apparatus according to claim 1, wherein the transfer roller has an elastic layer, and an opposite roller being in contact with the transfer roller via the transfer belt, in which the transfer roller has a diameter larger than that of the opposite roller.

6. The image forming apparatus according to claim 3, wherein a suction surface, which sucks the transfer material, of the suction unit is provided vertically downward the transport surface, which transports the transfer material, of the transfer material transporting unit.

7. An image forming method comprising:
carrying an image by a transfer belt;
transferring the image carried on the transfer belt to a transfer material by a transfer roller;
sucking a second surface, which is opposite to a first surface that is transferred the image, of the transfer material by a transfer material transporting unit using air flow to transport the transfer material along a transport surface; and
fixing the transfer material transported by the transfer material transporting unit.

8. The image forming method according to claim 7, wherein the transfer material transporting unit transports the transfer material, with the first surface that is transferred the image of the transfer material facing vertically downward.
